(19) United States
(12) Patent Application Publication
(10) Pub. No.: US 2024/0359696 A1
(43) Pub. Date: Oct. 31, 2024

(54) VEHICLE PREDICTIVE MODELING SYSTEM AND METHOD

(71) Applicant: Harley-Davidson Motor Company, Inc., Milwaukee, WI (US)

(72) Inventors: Jonathan BELL, Milwaukee, WI (US); Oswaldo GONZALEZ DELGADO, Milwaukee, WI (US)

(73) Assignee: Harley-Davidson Motor Company, Inc., Milwaukee, WI (US)

(21) Appl. No.: 18/644,836

(22) Filed: Apr. 24, 2024

Related U.S. Application Data
(60) Provisional application No. 63/498,180, filed on Apr. 25, 2023.

(51) Int. Cl. B60W 50/00; B60W 50/10; G07C 9/00

(52) U.S. Cl. CPC B60W 50/0097; B60W 50/10; G07C 9/00309; G07C 9/00896; B60W 2300/36; B60W 2556/10; B60W 2556/50; G07C 2009/00928; G07C 2209/63

(57) ABSTRACT

A computing device, a computer program product, and a computer-implemented method for utilizing predictive modeling in order to predict whether a driver of a vehicle is ultimately going to return to his/her house. If it is predicted that the driver is intending to return to his/her house, then an automatic action may be taken, such as opening a garage door to the house. A machine learning model may be added to the system to improve accuracy of the prediction.

### CROSS REFERENCE TO RELATED APPLICATIONS

This Application claims benefit to U.S. Provisional Application No. 63/498, 180, filed Apr. 25, 2023, which is incorporated by reference herein in its entirety for all purposes.

### TECHNICAL FIELD

One or more embodiments relate generally to a computing device, computer program product, and computer-implemented method for implementing a predictive modeling system to determine when a vehicle is headed to a user's home, upon which a particular physical action may then be initiated.

### BACKGROUND

Systems may determine whether a vehicle is inside a geofence. For example, a geofence may be a particular number of miles from a physical location.

However, this may not be an accurate method to determine if the vehicle is being driven to the physical location. For example, the vehicle may be near the physical location, but the vehicle may still end up being driven away from the physical location without stopping at the physical location.

### BRIEF SUMMARY

In accordance with one or more embodiments, a vehicle predictive modeling system is provided to predict whether a vehicle is going to be driven directly home.

In accordance with one or more embodiments, an example computer-implemented method of predicting whether a vehicle is returning to a location and conditionally initiating an automatic action is provided, the method comprising: determining, using one or more processors, that the vehicle is headed towards the location and that a driving distance to the location is lower than a predetermined distance; and initiating, using the one or more processors, in response to the determining, an action.

In accordance with the example computer-implemented method, the initiating the action comprises opening a garage door at the location.

In accordance with the example computer-implemented method, the initiating of the action comprises opening a window on a user interface.

In accordance with the example computer-implemented method, the determining that the vehicle is headed towards the location comprises determining that a driving distance between the vehicle and the location is decreasing.

In accordance with the example computer-implemented method, the method further comprises training a machine learning model using historical GPS data for a driver of the vehicle; using the machine learning model to determine a score indicative of whether the driver is intending to return to the location, wherein the initiating is also responsive to the score.

In accordance with the example computer-implemented method, the historical GPS data comprises a set of physical locations the vehicle was at and times the vehicle was at those respective locations.

In accordance with the example computer-implemented method, the method further comprises maintaining separate training data for respective drivers of the vehicle.

In accordance with one or more embodiments, an example computer program product is provided comprising at least one non-transitory computer readable medium having with a set of instructions of computer-executable program code, which when executed by one or more processors of a computing device, cause the computing device to: determine whether a vehicle is headed towards a location; determine whether a driving distance to the location is lower than a predetermined distance; and initiate, when the vehicle is headed towards the location and the driving distance to the location is lower than the predetermined distance, an action.

In accordance with one or more embodiments, an example computer program product is provided wherein the set of instructions is further programmed such that the action comprises opening a garage door at the location.

In accordance with one or more embodiments, an example computer program product is provided wherein the set of instructions is further programmed such that the action comprises opening a window on a user interface.

In accordance with one or more embodiments, an example computer program product is provided wherein the set of instructions is further programmed such that the determine whether the vehicle is headed towards the location comprises determining that a driving distance between the vehicle and the location is decreasing.

In accordance with one or more embodiments, an example computer program product is provided wherein the set of instructions is further programmed to cause the computing device to perform: training a machine learning model using historical GPS data for a driver of the vehicle; using the machine learning model to determine a score indicative of whether the driver is intending to return to the location, wherein whether the initiate is performed is also based upon the score.

In accordance with one or more embodiments, an example computer program product is provided wherein the set of instructions is further programmed such that the historical GPS data comprises a set of physical locations the vehicle was at and times the vehicle was at those respective locations.

In accordance with one or more embodiments, an example computer program product is provided wherein the set of instructions is further programmed to cause the computing device to perform: maintaining separate training data for respective drivers of the vehicle.

In accordance with one or more embodiments, an example apparatus is provided comprising: one or more processors; a non-transitory memory coupled to one or more processors, the non-transitory memory including a set of instructions of computer-executable program code, which when executed by the one or more processors, cause the apparatus to, determine whether a vehicle is headed towards a location; determine whether a driving distance to the location is lower than a predetermined distance; and cause, when the vehicle is headed towards the location and the driving distance to the location is lower than the predetermined distance, performance of an action.

In accordance with one or more embodiments, an example apparatus is provided further comprising a motorcycle attached to the one or more processors and the non-transitory memory.

In accordance with one or more embodiments, an example apparatus is provided wherein the set of instructions, which when executed by the one or more processors, enables the action to comprise opening a garage door at the location.

In accordance with one or more embodiments, an example apparatus is provided, wherein the set of instructions, which when executed by the one or more processors, enables the action to comprise opening a window on a user interface.

In accordance with one or more embodiments, an example apparatus is provided, wherein the set of instructions, which when executed by the one or more processors, further causes the apparatus to: train a machine learning model using historical GPS data for a driver of the vehicle; use the machine learning model to determine a score indicative of whether the driver is intending to return to the location, wherein whether the performance of the action is performed is also based upon the score.

In accordance with one or more embodiments, an example apparatus is provided, wherein the set of instructions is further programmed such that the historical GPS data comprises a set of physical locations the vehicle was at and times the vehicle was at those respective locations.

In accordance with one or more embodiments, a switching system is provided to utilize a home WIFI router to enable communications from and to a vehicles computer system.

In accordance with one or more embodiments, an example computer-implemented method of maintaining a wireless connection is provided, the method comprising establishing a wireless connection between a computer system and a first wireless access point, determining that a second wireless access point is available, the second wireless access point being located at a home, the second wireless access point being a Wi-Fi router; and switching the wireless connection from the first wireless access point to the second wireless access point.

In accordance with the example computer-implemented method, before the determining that the second wireless access point is available, determining that the computer system is within a predetermined distance from the home.

In accordance with the example computer-implemented method, the first wireless access point is a cellular phone.

In accordance with the example computer-implemented method, the computer system is attached to a motorcycle.

In accordance with the example computer-implemented method, the motorcycle is physically moving.

In accordance with the example computer-implemented method, before the switching, notifying a user that the wireless connection is being changed from the first wireless access point to the second wireless access point.

In accordance with the example computer-implemented method, registering an identification of the second access point.

In accordance with the example computer-implemented method, identifying a physical location of the second access point.

In accordance with the example computer-implemented method, completing an upload or download of a file to a remote server using the second wireless access point.

In accordance with one or more embodiments, an example computer program product is provided comprising at least one non-transitory computer readable medium having with a set of instructions of computer-executable program code, which when executed by one or more processors of a computing device, cause the computing device to: establish a wireless connection with a first wireless access point, determine that a second wireless access point is available, the second wireless access point being associated with a home, the second wireless access point being a WIFI router, and switch the wireless connection from the first wireless access point to the second wireless access point.

In accordance with one or more embodiments, an example computer program product is provided wherein the set of instructions is further programmed to cause, before the determining that the second wireless access point is available, determining that the computer system is within a predetermined distance from the home.

In accordance with one or more embodiments, an example computer program product is provided wherein the set of instructions is further programmed to notify a user that the wireless connection is being changed from the first wireless access point to the second wireless access point.

In accordance with one or more embodiments, an example computer program product is provided wherein the set of instructions is further programmed to identify a physical location of the second access point.

In accordance with one or more embodiments, an example apparatus is provided comprising one or more processors, a non-transitory memory coupled to the one or more processors, the non-transitory memory including a set of instructions of computer-executable program code, which when executed by the one or more processors, cause the apparatus to establish a wireless connection with a first wireless access point, determine that a second wireless access point is available, the second wireless access point being located at a home, the second wireless access point being a Wi-Fi router; and switch the wireless connection from the first wireless access point to the second wireless access point.

In accordance with one or more embodiments, an example apparatus is provided wherein the set of instructions, which when executed by the one or more processors, determines that the computer system is within a predetermined distance from the home.

In accordance with one or more embodiments, an example apparatus is provided wherein the set of instructions, which when executed by the one or more processors, enables the first wireless access point is a cellular phone.

In accordance with one or more embodiments, an example apparatus is provided wherein the set of instructions, which when executed by the one or more processors, before the switching, notifying a user that the wireless connection is being changed from the first wireless access point to the second wireless access point.

In accordance with one or more embodiments, an example apparatus is provided wherein the set of instructions, which when executed by the one or more processors, registers an identification of the second access point.

In accordance with one or more embodiments, an example apparatus is provided wherein the set of instructions, which when executed by the one or more processors, identifies a physical location of the second access point.

In accordance with one or more embodiments, an example apparatus is provided wherein the set of instructions, which when executed by the one or more processors, completes an upload or download of a file to a remote server using the second wireless access point.

### BRIEF DESCRIPTION OF THE SEVERAL VIEWS OF THE DRAWINGS

The various advantages of the exemplary embodiments will become apparent to one skilled in the art by reading the following specification and appended claims, and by referencing the following drawings, in which:

FIG. 1 illustrates a communication environment, in accordance with one or more embodiments set forth and described herein.

FIG. 2 illustrates a block diagram showing a computer system built into the vehicle, in accordance with one or more embodiments set forth and described herein.

FIG. 3 illustrates a flowchart for a computer-implemented method for automatically initiating an action, in accordance with one or more embodiments set forth and described herein.

FIG. 4 illustrates a sample map, in accordance with one or more embodiments set forth and described herein.

FIG. 5 illustrates a map showing a geofence and a vehicle, in accordance with one or more embodiments set forth and described herein.

FIG. 6 illustrates a map showing an approaching vehicle, in accordance with one or more embodiments set forth and described herein.

FIG. 7 illustrates a flowchart for a computer-implemented method for implementing a predictive modeling system, in accordance with one or more embodiments set forth and described herein.

FIG. 8 illustrates a flowchart for a computer-implemented method for opening a garage door using an interactive garage door opener, in accordance with one or more embodiments set forth and described herein.

FIG. 9 illustrates a block diagram showing a garage door and controller, in accordance with one or more embodiments set forth and described herein.

FIG. 10 illustrates a flowchart for a computer-implemented method for implementing a predictive modeling system using artificial intelligence, in accordance with one or more embodiments set forth and described herein.

FIG. 11 illustrates a flowchart for a computer-implemented method for implementing a customized geofence set by a user, in accordance with one or more embodiments set forth and described herein.

FIG. 12 illustrates an example output showing a map and input of a customized geofence from a user, in accordance with one or more embodiments set forth and described herein.

FIG. 13 illustrates a flowchart for a computer-implemented method for combining multiple sources of GPS data, in accordance with one or more embodiments set forth and described herein.

FIG. 14 illustrates a communication environment with a home Wi-Fi router, in accordance with one or more embodiments set forth and described herein.

FIG. 15 illustrates a flowchart for a computer-implemented method for initializing a home Wi-Fi router, in accordance with one or more embodiments set forth and described herein.

FIG. 16 illustrates a flowchart for a computer-implemented method for switching communication from a first access point to the home Wi-Fi router, in accordance with one or more embodiments set forth and described herein.

FIG. 17 illustrates a flowchart for a computer-implemented method for implementing software updates for vehicles over the air, in accordance with one or more embodiments set forth and described herein.

### DETAILED DESCRIPTION

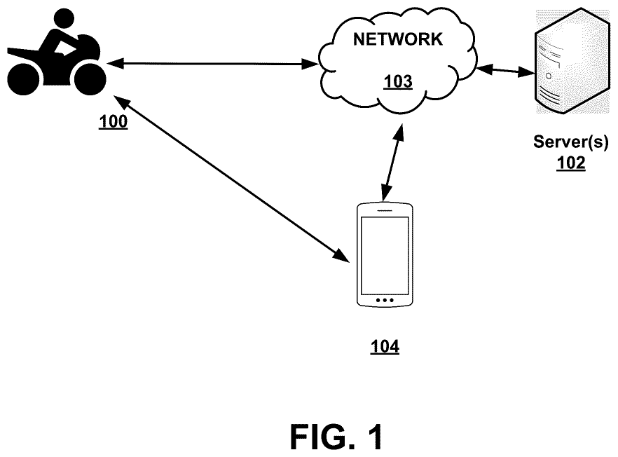

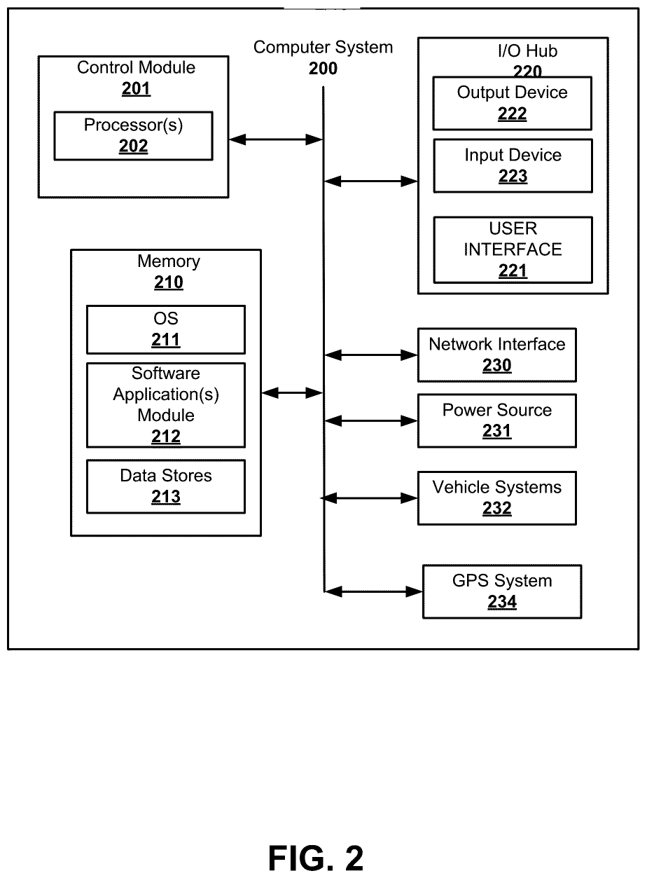

As illustrated in FIG. 1, a communication environment is shown. A computer system 100 (of the kind illustrated in FIG. 2) is attached to a vehicle such as a motorcycle (although it may be any other type of vehicle such as an automobile). The computer system 100 may communicate with a computer communications network 103 (such as the Internet) using an internet adapter. One or more server(s) 102 are also in communication with the network 103 using the server(s) 102 own internet adapter(s). As such, the computer system 100 is able to communicate with remote server(s) 102 which may provide all sorts of information, for example navigation maps, updates to software, etc. A cellular phone 104 (e.g., a “smart phone”) which is located inside the vehicle may also be in communication with the computer communications network 103 and then to the computer system 100, and/or in communication with the computer system 100 via a local connection such as BLUETOOTH. The computer system 100 may control applications and functionality on the cellular phone 104, and the cellular phone 104 may also control applications and functionality on the computer system 100.

As illustrated in FIG. 2, a block diagram shows a computer system 200 which is built into the vehicle (referred to as computer system 100 in FIG. 1). The computer system may be located anywhere on the vehicle. A control module 201 serves as a host, main, or primary control system of the vehicle. For example, the control module 201 may comprise an electronic or engine control unit (ECU). The control module 201 may comprise one or more processors 202. As set forth, described, and/or illustrated herein, “processor” means any component or group of components that are operable to execute any of the processes described herein or any form of instructions to carry out such processes or cause such processes to be performed. The processors 202 may be implemented with one or more general-purpose and/or one or more special-purpose processors. Examples of suitable processors include graphics processors, microprocessors, microcontrollers, DSP processors, and other circuitry that may execute software (e.g., stored on a non-transitory computer-readable medium). Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The processors 202 may comprise at least one hardware circuit (e.g., an integrated circuit) operable to carry out instructions contained in program code. In embodiments having a plurality of processors 202, such processors 202 may work independently from each other, or one or more processors may work in combination with each other. Note that any and all of the features described herein may be programmed and stored in the memory 210 which would cause the processors 202 to implement any and all of the features described herein. Alternatively, any and all of the features described herein may also be stored in a remote memory (e.g., on a remote server) and executed by one or more processors that are not located on the vehicle, with the results being communicated to the computer system 200 on the vehicle.

In accordance with one or more embodiments, the computer system 200 comprises an I/O hub 220 operatively connected to other systems and subsystems of the vehicle. The I/O hub 220 may comprise a user interface 221 which may receive inputs from the user and display data to the user. The user interface 221 may be integrated as a single, unitary interface, or alternatively, be separate as independent interfaces that are operatively connected. The I/O hub 220 may also comprise an electronic output device 222, such as an LCD display, speaker (for audible output), etc. The I/O hub 220 may also comprise an electronic input device 223, such as a touch-screen display, buttons, microphone (for spoken input), etc.

In one or more embodiments, the user interface 221 may be used by a user, such as, for example, a user, operator, or rider of the vehicle, to input data. The user interface 221 is defined herein as any device, component, system, subsystem, element, or arrangement or groups thereof that enable information/data to be entered in a machine. The user interface 221 may receive an input from a vehicle operator (e.g., a driver or rider of the vehicle) or a remote operator of the vehicle. In one or more example embodiments, the user interface 221 may comprise graphical user interface (GUI) such as, for example, a display, human-machine interface (HMI), or the like. Embodiments, however, are not limited thereto, and thus, this disclosure contemplates the input interface comprising any suitable configuration that falls within the spirit and scope of the principles of this disclosure. For example, the input interface may comprise a keypad, toggle switch, touch screen, multi-touch screen, button, joystick, mouse, trackball, microphone and/or combinations thereof.

The user interface 221 may also include any device, component, system, subsystem, element, or arrangement or groups thereof that enable information/data to be presented to the vehicle operator and/or a remote operator of the vehicle 10. The user interface 221 may be operable to present information/data to the vehicle occupant and/or the remote operator. The user interface 221 may comprise one or more of a visual display or an audio display such as a microphone, earphone, and/or speaker. One or more components of the vehicle 10 may serve as both a component of the input interface and a component of the output interface.

In accordance with one or more embodiments, the computer system 200 comprises memory 210 which may comprise one or more data stores 213 for storing one or more types of data. The computer system 200 may include interfaces that enable one or more systems thereof to manage, retrieve, modify, add, or delete, the data stored in the data stores 213. The data stores 213 may comprise volatile and/or non-volatile memory. Examples of suitable data stores 30 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data stores 213 may be a component of the processors 202, or alternatively, may be operatively connected to the processors 202 for use thereby. As set forth, described, and/or illustrated herein, “operatively connected” may include direct or indirect connections, including connections without direct physical contact.

The memory 210 may also store an operating system 211 which is programmed with basic functions (e.g., input, output, etc.) which enable the computer system 200 to operate. The memory 210 may also include software application modules 212 which may utilize the operating system 200 and may implement functionality to perform any programmed function, including any feature described herein.

A network interface 230 enables the computer system 200 to communicate with any computer communications network, such as Wi-Fi, Bluetooth, the internet, etc. A power source 231 provides any needed power to the system. Vehicle systems 232 may be any vehicle system that interfaces with the computer system 200 and may be monitored and/or controlled by the computer system 200.

In accordance with one or more embodiments, operation of the control module 201 may be implemented as computer readable program code that, when executed by a processor, implement one or more of the various processes set forth, described, and/or illustrated herein. The control module 201 may be a component of the processors 202, or alternatively, may be executed on and/or distributed among other processing systems to which the processors 202 are operatively connected. The control module 201 may include a set of logic instructions executable by the processors 202. Alternatively, or additionally, the data stores 213 may contain such logic instructions. The logic instructions may include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

The control module 201 may also be connected to a GPS system 234, which may provide real time location data (in the form of coordinates, etc.) The location data may be determined from signals received from GPS satellites and/or cell phone towers, or any other geolocation technique.

In accordance with one or more embodiments, when a vehicle is approaching a user's (e.g., the driver/rider of the vehicle) home, an action may be automatically initiated. The action may be, for example, opening a garage door. The action may also be opening a pop-up window on the user's cell phone or on a user interface on the vehicle itself. The pop-up window may display a button which easily enables the user to open a garage door. The automatic action is a convenience for the user, since when the user is close to home, the action (e.g., opening a garage door) is initiated without the user having to manually initiate it on his/her own.

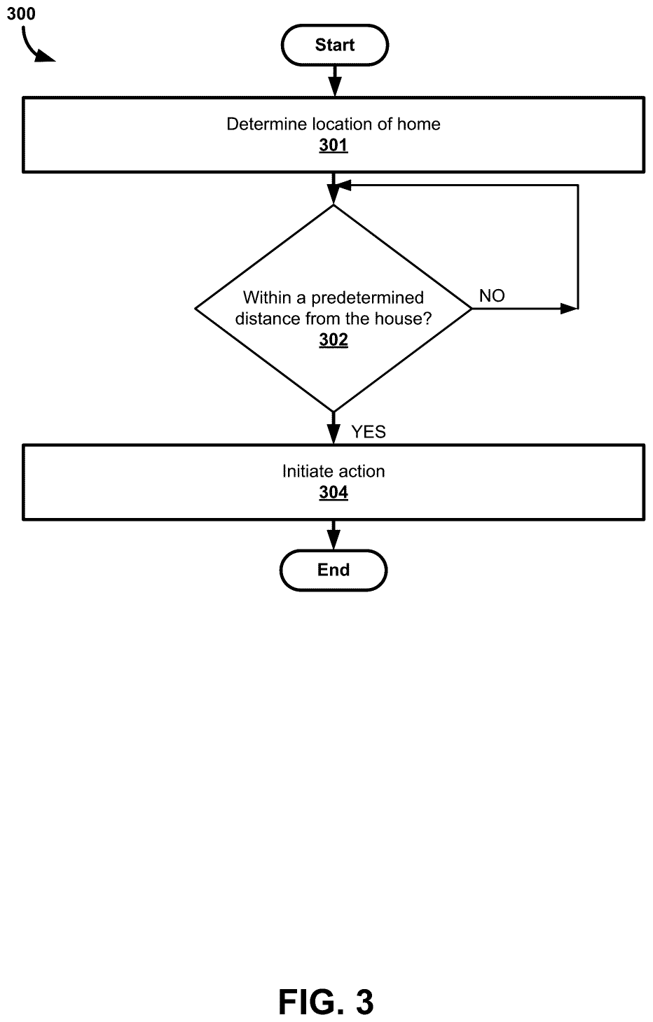

Illustrated examples in FIGS. 3, 7-8, 10, set forth. In one or more examples, the respective flowcharts of the computer-implemented methods may be implemented by the one or more processors 202 of the computer system 200 mounted on or inside the vehicle. In particular, the computer-implemented methods may be implemented as one or more modules in a set of logic instructions stored in a non-transitory machine-or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof.

As illustrated in FIG. 3, a computer-implemented method for automatically initiating an action is shown, in accordance with one or more embodiments set forth and described herein. In illustrated process block 301, the location of the user's house is determined. This may be performed in numerous ways, for example, inputting an address of the user's home directly from the user, receiving a button press when the vehicle is located at the user's house which automatically retrieves the GPS coordinates of the vehicle, automatically detecting where the vehicle stationary for long periods of time (or overnight), etc. The method may then proceed to illustrated decision block 302, which determines if the vehicle is within a predetermined distance from the house. For example, a geofence may include anything within a predetermined distance (e.g., one mile, 500 feet, etc.) from the user's house. If the vehicle is determined (from its GPS data) to be not within a predetermined distance from the house (e.g., within the geofence) then the method would repeat illustrated decision block 302 and continue to make this determination. If the vehicle is determined to be within the predetermined distance from the house (e.g., within the geofence), then the method would proceed to illustrated process block 304, which initiates the action. The action, as stated herein, may be opening a garage door, opening a pop-up window, or any other appropriate action. A garage door may be automatically opened by transmitting (e.g., from the network interface 230) a signal to a garage door opener to open the door. A pop-up window may be automatically opened by requesting that the pop-window be displayed on the output device 222 or an output device of a cell phone paired with the computer system 200. The action may also be automatically opening an app or interface which may provide for further functionality (e.g., display a large button to manually open the garage door).

Note that as the vehicle leaves the garage, the garage door may automatically be closed. The computer system 200 could track the location of the vehicle via GPS and once it leaves the garage it may trigger an automatic closing of the garage door. Note that in an embodiment, the distance the vehicle is from the garage door to trigger an automatic open and close would vary based on whether the vehicle is pulling into the garage or departing from the garage. For example, if the vehicle is leaving the garage, a distance of only 20 feet (just one example) may be used before the garage door is automatically closed. However, when automatically opening the garage door as the vehicle is pulling into the garage, a distance of 40 feet (just an example) would trigger the garage door to automatically open. Thus, when the vehicle is pulling into a driveway and ultimately the garage, the distance from the garage that would automatically trigger the garage door to open would be greater than the distance from the garage the vehicle would be when the vehicle was leaving the garage before an automatic closing operation is triggered.

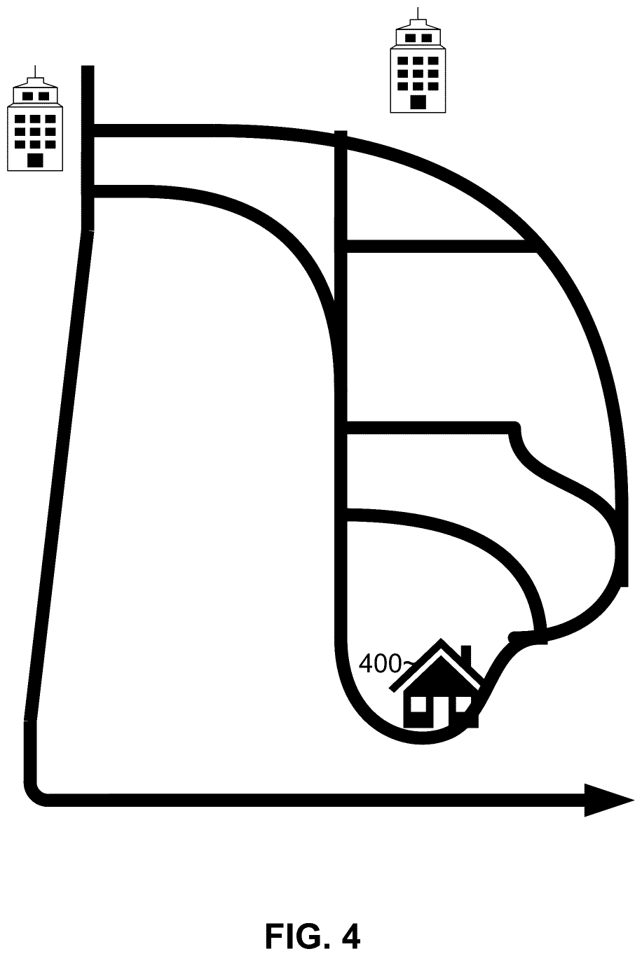

As illustrated in FIG. 4, a sample map is shown, in accordance with one or more embodiments set forth and described herein. A sample map is illustrated which shows the user's house 400. Note that such a map may be downloaded to the computer system 200 from an external server (e.g., GOOGLE maps, etc.) which may be server(s) 102. All distances (e.g., driving distances, etc.) and road configuration may be determined from the downloaded assets.

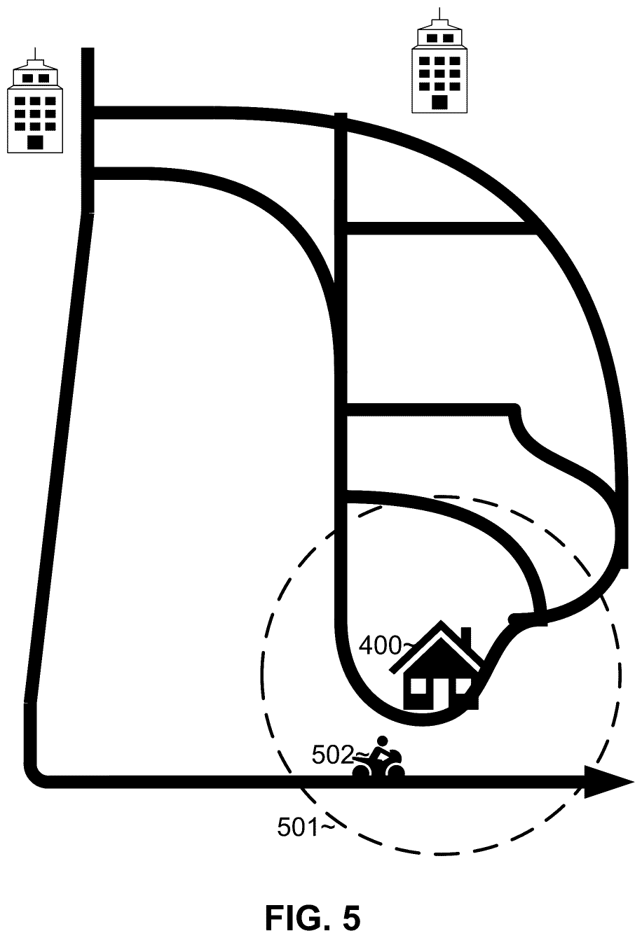

As illustrated in FIG. 5, a sample map is shown with a geofence and a vehicle, in accordance with one or more embodiments set forth and described herein. A geofence 501 is shown on the map, which is a circle with a radius of a predetermined length representing the size of the geofence. The vehicle 502 is inside the geofence. It is noted that the vehicle 502 is drawing away from the house 400 even though the vehicle 502 is inside the geofence.

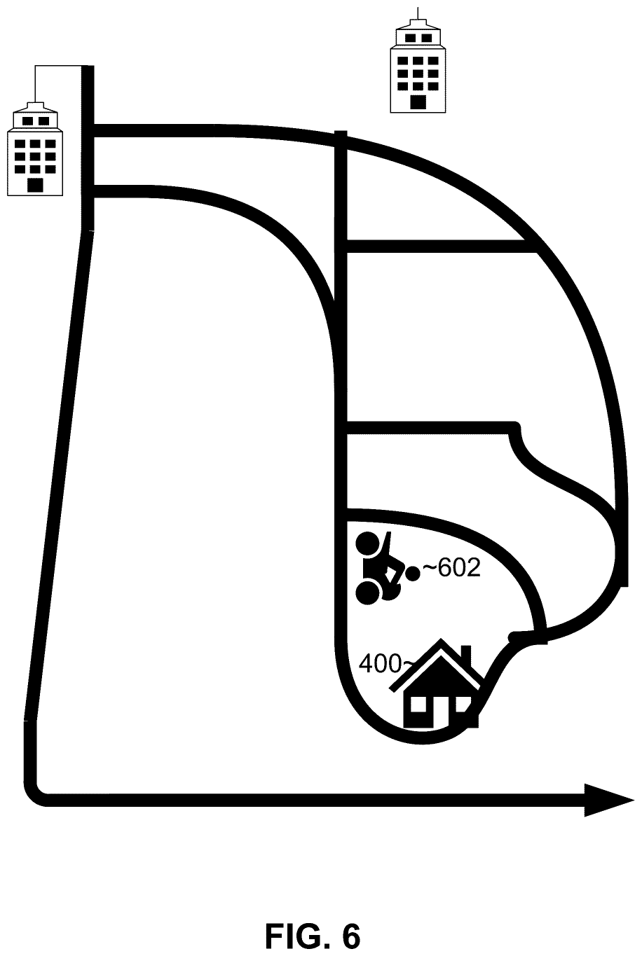

As illustrated in FIG. 6, a map is shown with an approaching vehicle, in accordance with one or more embodiments set forth and described herein. A vehicle 602 is shown headed towards the house 400. In this example, it appears very likely that the user of the vehicle 602 intends to stop at the house 400.

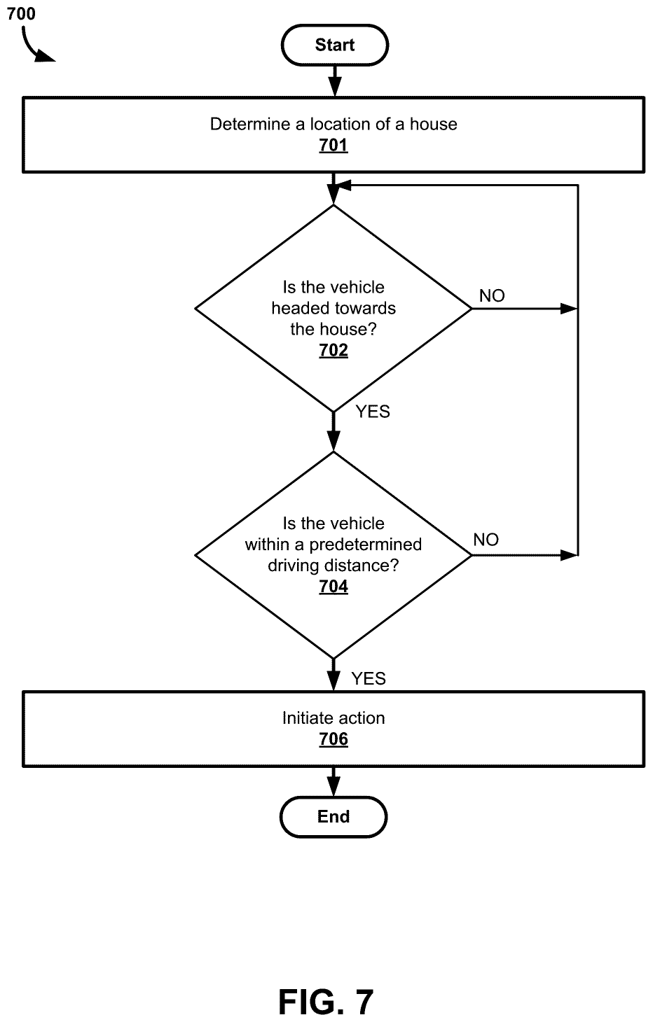

As illustrated in FIG. 7, a flowchart for a computer-implemented method is shown for implementing a predictive modeling system, in accordance with one or more embodiments set forth and described herein. in illustrated process block 701, the location of the user's house is determined, as described herein. The method may then proceed to decision block 702, which determines whether the vehicle is headed towards the house. In other words, if the driving distance from the vehicle to the house is decreasing then the vehicle is headed towards the house, and if the driving distance from the vehicle to the house is increasing then the vehicle is not headed towards the house (but headed away from the house). The driving distance is the distance by taking the shortest route driving (which is different than the distance between the two points or “as the crow flies.”) If in decision block 702, it is determined that the vehicle is not headed towards the house, then the method may repeat decision block 702. If in decision block 702, it is determined that the vehicle is headed towards the house, then the method may proceed to decision block 704 which determines whether the vehicle is within a predetermined driving distance from the house. The predetermined driving distance would typically be a short distance, for example 500 feet. If the vehicle is not within the predetermined driving distance, then the method returns to decision block 702. If in operation 704, it is determined that the vehicle is within the predetermined driving distance, then the method may proceed to illustrated process block 706, which initiates an action. The action, as described herein, may be any action that provides convenience to the user as the user is determined to be approaching his/her house. For example, the garage door may be opened, a pop-up window on the user's phone or an electronic output device inside the vehicle may be displayed. Note that decision blocks 702 and 704 may be performed in either order.

Some garage door openers are configured to detect a particular signal, and upon detection, will open the garage door if it is already closed and close the garage door if it is already open. This can create an issue if the garage door is already open and then the user drives his/her vehicle to his/her house and then the computer system 100 will transmit a signal to “open” the garage door but since the garage door is already open this will have the effect of closing the garage door. This issue can be addressed with a more advanced garage door opener which may transmit a state of the garage door (open/closed) upon request.

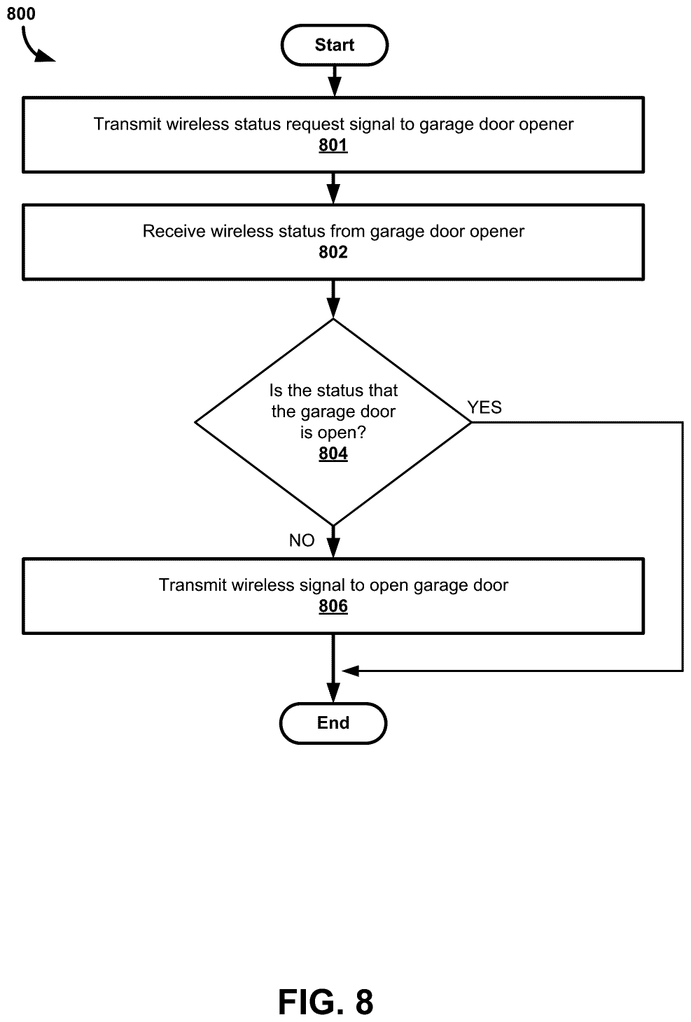

As illustrated in FIG. 8, a flowchart for a computer implemented method 800 is shown for opening a garage door using an interactive garage door opener, in accordance with one or more embodiments set forth and described herein. In illustrated process block 801, the computer system 100 transmits a wireless signal which is recognized by a garage door opener as a status request. There can be different models of garage door openers and the user may identify which model of garage door opener is present in the garage in the user's house to the computer system 100 using the user interface so that the computer system 100 may communicate with the garage door opener using the right protocol (e.g., frequency, etc.) In illustrated process block 802, the computer system 100 receives a wireless signal from the garage door opener indicates its status (open/closed). The method then proceeds to illustrated process block 804, which determines if the garage door is open. If the garage door is open, then the method terminates as the garage door is already open. If in illustrated decision block 804 the garage door is not open, then the method proceeds to illustrated process block 806 which transmits a wireless signal to the garage door opener to open the garage door. In this manner, if the garage door is already open, it will remain open and not be automatically closed when the vehicle returns to the garage.

Note that the garage door opener may also be connected to the internet via an “internet of things” protocol. In an embodiment, the computer system 100 may also communicate with the garage door opener via the internet as the garage door opener would have its own IP address. The computer system 100 may command the garage door opener to open using such a protocol via the internet.

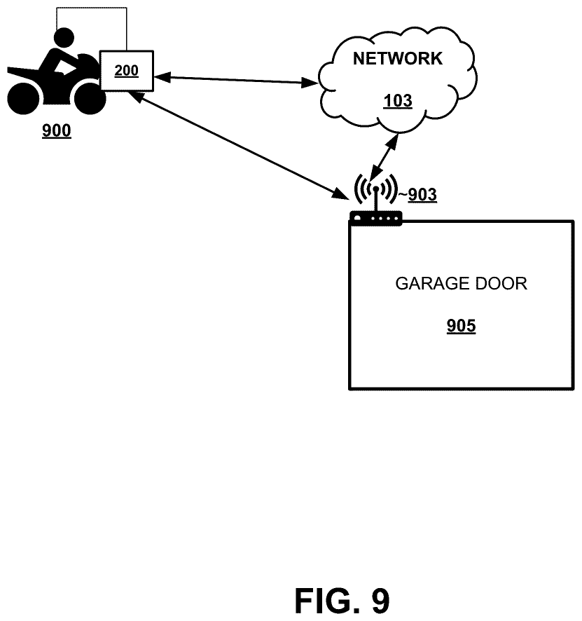

As illustrated in FIG. 9, a block diagram is shown illustrating a garage door and controller, in accordance with one or more embodiments set forth and described herein. The vehicle 900 contains the computer system 200 (attached to the vehicle 900), although typically the computer system 200 would be hidden inside the vehicle except for any input and output devices. The computer system 200 may communicate wirelessly in both directions with garage door controller 903 and may wirelessly open and close the garage door 905 (as well as determine its status). In an alternative embodiment, the computer system 200 may communicate with the garage door controller 903 via the network 103 (e.g., internet) as the garage door controller 903 is also connected to the internet (e.g., via a Wi-Fi router or other bridge). In this embodiment, the garage door controller 903 may operate via an “internet of things” protocol.

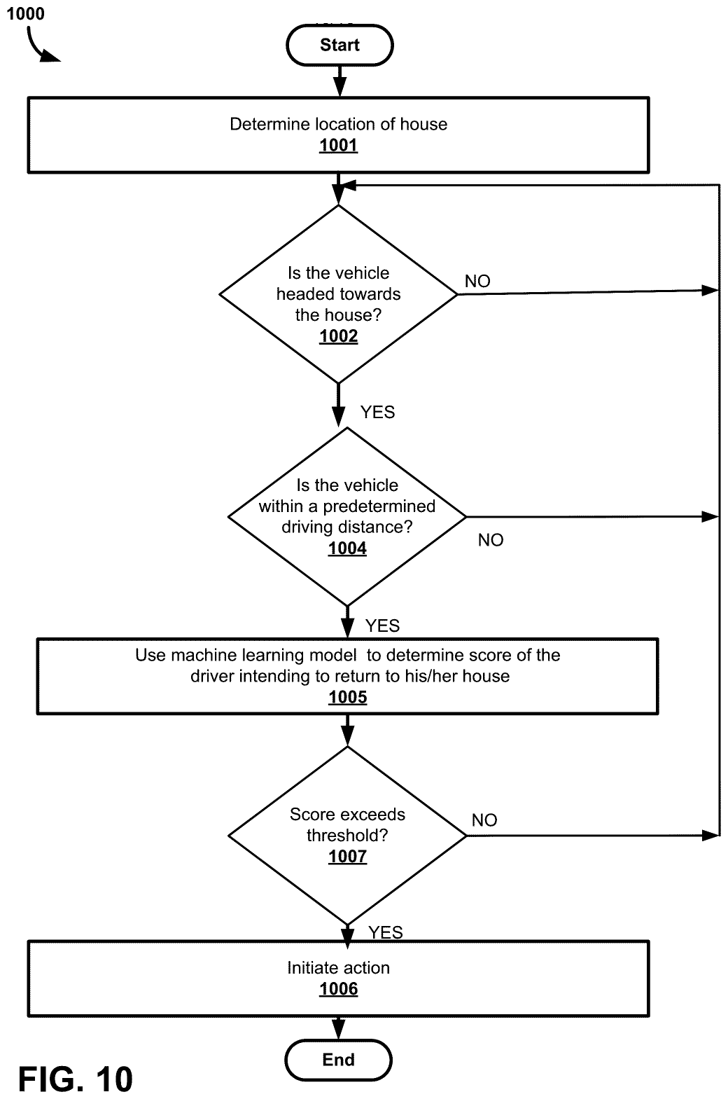

As illustrated in FIG. 10, a flowchart for a computer-implemented method is shown for implementing a predictive modeling system using artificial intelligence, in accordance with one or more embodiments set forth and described herein. Illustrated blocks 1001, 1002, 1004, 1006, are all implemented as described in FIG. 7 with regard to illustrated blocks 701, 702, 704, 706, respectively. FIG. 10 adds illustrated process block 1005 and illustrated decision block 1007 which adds another operation of utilizing artificial intelligence (machine learning, etc.) in order to improve on the results from FIG. 7.

In illustrated process block 1005, a machine learning model is used in order to determine a score which is a measure of the probability (or strength) of the driver intending to return to his/her house. The machine learning models may be, for example, classification, regression, clustering, dimensionality reduction, convolutional neural networks, recurrent neural networks, deep neural network, etc. Various factors may be input into the model over time which are used to train the machine learning model. For example, the driver's historical routes (roads driven on) may be tracked (using GPS), stored, and used as inputs into the system. For example, if a driver is more likely at an intersection to take a turn which does not lead to the driver's house, then when the driver is at this intersection the model would weigh this factor against the driver intending to return to his/her house. The driver's historical times the driver has returned home. For example, if the driver tends to return home only after 8 pm each night, and if the current time is 1 pm, the model would weigh this factor as the driver is less likely to be intending to return home at this time. Another factor that may be used to train the system is the driver's preferred routes to return home. A driver may favor certain routes to return home and other routes to go elsewhere, and based on a path the driver is taking, this may also be used as input to help predict whether the driver is intending to return home.

Additional factors may be utilized in the machine learning model as well. For example, the speed of the vehicle (e.g., motorcycle) may be incorporated into the model as a predictive factor. For example, if the vehicle is close to the home but there are no changes in speed, this might weigh towards the conclusion that the vehicle is not headed towards the home. If the vehicle is located inside the garage of the home, and the vehicle starts moving, then the garage door (or other action) may automatically be prompted or taken.

Because different drivers of a vehicle may have different habits, the vehicle should identify each driver and utilize data/models for only that particular driver. The system may identify drivers by using numerous methods, for example facial recognition, or the driver may entire his/her name into the user interface 221.

A numerical score may be computed which is a measure of the strength or probability that the driver is intending to return home. The numerical score is computed using the machine learning model which was trained on data from the particular driver currently driving. The higher the score, the more likely the driver is intending to return home, although alternatively the lower the score, the more likely the driver is intending to return home. As such, a predetermined threshold is used to compare the score to. If the score is higher than the predetermined threshold (or in an alternate embodiment, lower than the predetermined threshold), then the method would determine that the driver is indeed intending to return home.

From illustrated process block 1005, the method may proceed to illustrated decision block 1007 which determines whether the score computed in illustrated process block 1005 exceeds a predetermined threshold. If the score does not exceed the predetermined threshold, then the method returns to decision block 1002 which repeats the process. If the score exceeds the predetermined threshold, then the method proceeds to illustrated process block 1006 which would initiate the action, as described herein. Note that in an alternate embodiment (with an inverse scale), in decision block 1007, if the score does not exceed the predetermined threshold then the method would proceed to illustrated process block 1006 and if the score exceeds the predetermined threshold then the method would return to decision block 1002. As such, the method illustrated in FIG. 10 would result in an accurate prediction of whether the driver is intending to drive the vehicle to his/her house. The model would gain accuracy as the system is trained with additional data, in other words, the longer the driver has been utilizing the vehicle, the more accurate the model will become.

In accordance with a further embodiment, a customized geofence may be implemented. Referring to decision block 302, from FIG. 3, a geofence may be defined as a predetermined linear distance from the user's home. In a further embodiment, the user may input (draw) his/her own customized geofence on a map which could suit his/her own preferences as to when he/she would want any automatic actions triggered.

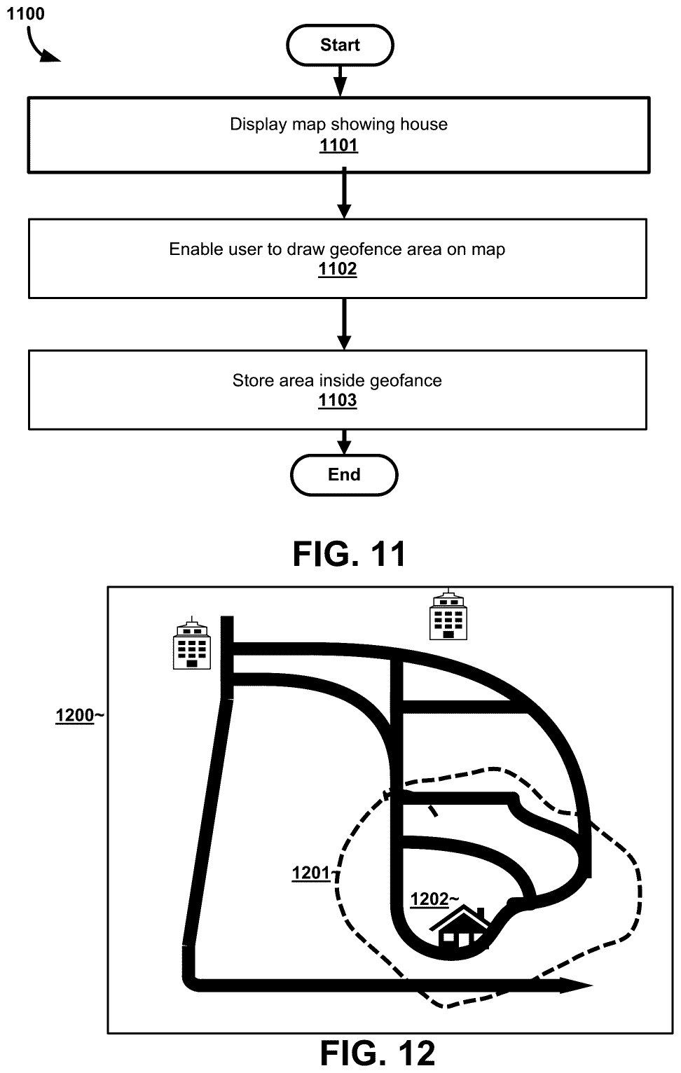

FIG. 11 illustrates a flowchart for a computer-implemented method for implementing a customized geofence set by a user, in accordance with one or more embodiments set forth and described herein.

The method can begin with process block 1100, which can display a map to a user showing the user's home and nearby vicinity (e.g., 1-5 miles radius from the home). From process block 1101, the method may proceed to process block 1102, which enables the user to draw a geofence on the screen around the home. The user may use any input device, such as a stylus, his/her finger on a touchscreen, mouse, etc., to draw the geofence. When the user indicates that he/she is finished drawing the custom geofence, then from process block 1102, the method may proceed to process block 1103, which stores the area inside the geofence for later retrieval. The area may be stored in numerous manners, such as a set of polygons which fall inside the customized geofence, the vectors of the lines drawn by the user, all of the points on the user's customized geofence, etc. Once stored, the custom geofence may be utilized by process block 302 (or anywhere else described herein when a user enters a predefined area) to determine whether to take any automatic action. Thus, for example, in process block 302, instead of determining whether a user is located within a predetermined distance of from the house, operation 302 would determine whether the user is located within the custom geofence.

FIG. 12 illustrates an example output showing a map and input of a customized geofence from a user, in accordance with one or more embodiments set forth and described herein. An example computer output 1200 shows the user's home 1202. Also shown is the user's customized geofence 1201 (which the user drew as described in process block 1102 from FIG. 11)

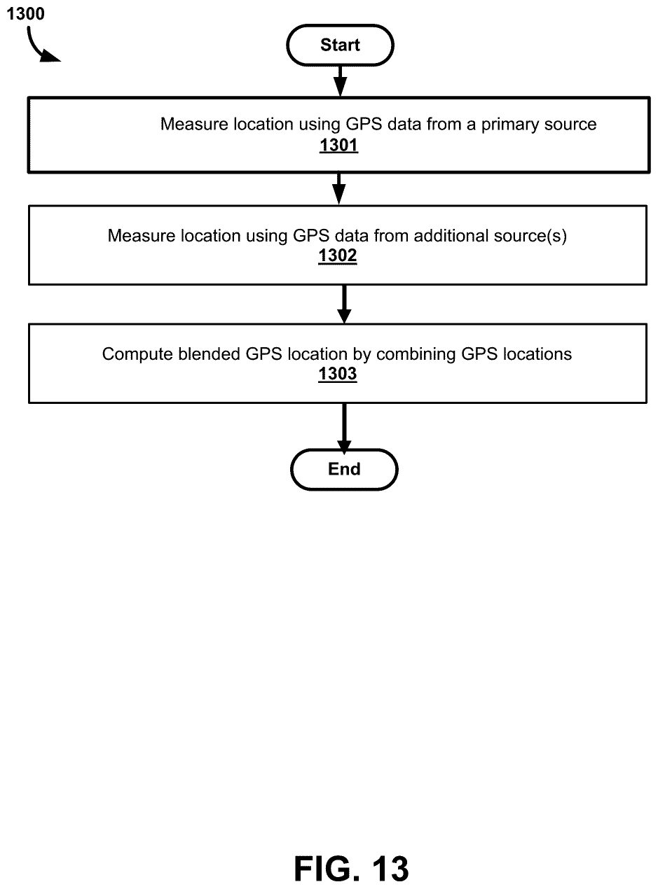

In a further embodiment, instead of using one source to determine the user's location (e.g., the GPS from the user's cell phone), multiple GPS sources may be utilized, thereby improving accuracy. The average of these multiple sources may be taken. FIG. 13 illustrates a flowchart for a computer-implemented method for combining multiple sources of GPS data, in accordance with one or more embodiments set forth and described herein. In process block 1301, the GPS location of the user may be obtained from a primary source. The primary source may be the user's cell phone, the vehicle's GPS chipset, etc. From process block 1301, the method may proceed to process block 1302, which measures the user's location using GPS data from one or more additional source(s). Additional sources may be the user's cell phone, the vehicle's GPS chipset, an auxiliary computer that is on the vehicle, or any other such GPS device. From process block 1302, the method may proceed to process block 1303, which then computers a blended GPS location (coordinates) by combining the GPS locations garnered from process blocks 1301 and 1302. The multiple instances of GPS data may be combined in numerous ways, for example they may be averaged. For example, the latitude coordinates may be averaged, and the longitude coordinates may be averaged, and then both averages may be the blended GPS location (which would presumably be more accurate than any of the individual GPS locations). Alternatively, a weighted average may be taken, in which the averaging method described above may be used by a weight may be assigned based on a presumed accuracy of each GPS chipset. For example, a cell phone GPS may have a weight of 2 while a vehicle GPS may have a weight of 1 (implying that the cell phone GPS is generally more accurate than the vehicle GPS), thus the GPS data from the cell phone would be weighted twice as heavily as the vehicle GPS. This method may be used to provide a location and/or GPS data for any use of location/GPS described herein.

In a further embodiment, a home network (such as a home Wi-Fi router) may be used to connect the computer system 100 to the computer communications network (such as the Internet). Thus, a user may utilize their cellular phone to connect the computer system 100 to the computer communications network while the user is on the road (away from home) but when the user is in close proximity of home, the computer system 100 may automatically “hand off” utilizing the cellular phone to utilizing the home Wi-Fi for connecting to the computer communications network.

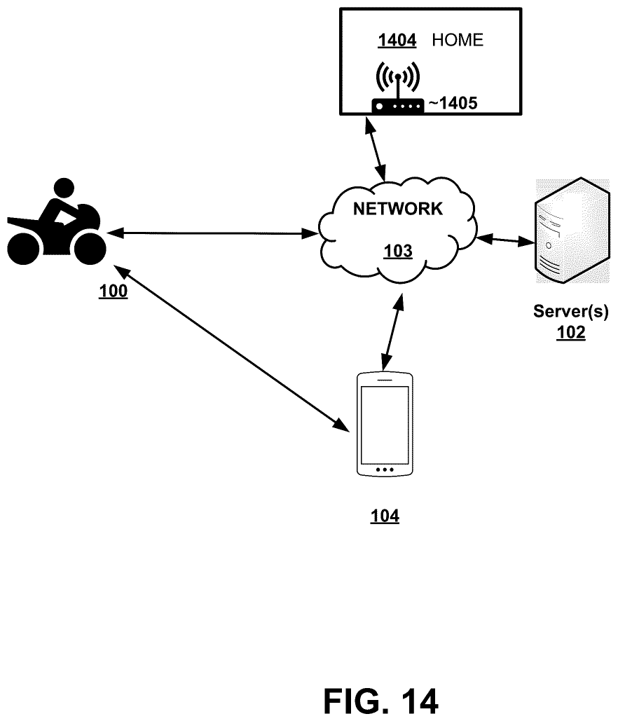

FIG. 14 illustrates a communication environment with a home Wi-Fi router, in accordance with one or more embodiments set forth and described herein. As illustrated in FIG. 13, a communication environment with a home Wi-Fi router is shown. A computer system 100 (of the kind illustrated in FIG. 2) is attached to a vehicle such as a motorcycle (although it may be any other type of vehicle such as an automobile). The computer system 100 may communicate with a computer communications network 103 (such as the Internet) using an internet adapter. One or more server(s) 102 are also in communication with the network 103 using the server(s) 102 own internet adapter(s). A cellular phone 104 (e.g., a “smart phone”) which may be located inside or near the vehicle may also be in communication with the computer communications network 103 (and ultimately server(s) 102 or any other device on the computer communications network 103) using cellular communication (e.g., 5G) and then to the computer system 100, and/or in communication with the computer system 100 via a local connection such as BLUETOOTH. Note that the computer system 100, only when in close proximity to a home Wi-Fi router 1405 located in a home 1404, may also connect to the computer communications network 103 via the Wi-Fi router 1405 instead of the cellular phone 104. Thus, when the motorcycle that is physically attached to the to the computer system 100 is located at the home 1404 (e.g., in the garage or driveway) then the computer system 100 may utilize the home Wi-Fi router 1405 which would free up the cellular phone 104. Note that the computer system 100 is attached to a motorcycle or other vehicle, and may be used to generate things like trip logs, etc. Periodically, the trip logs (and other files) should be uploaded to a remote server so they may be stored and made available for retrieval. Thus, a constant connection to the internet should typically be maintained when possible.

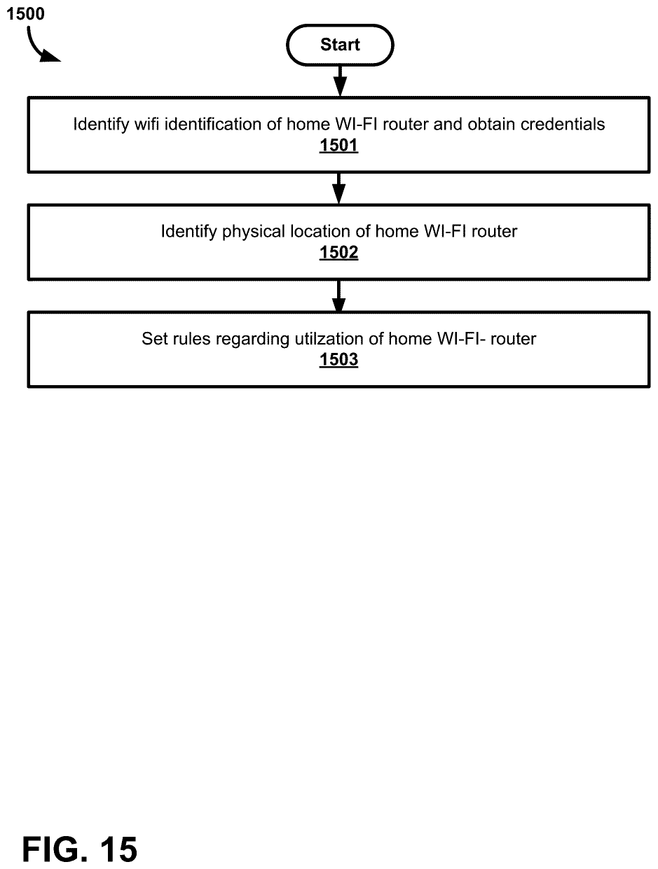

FIG. 15 illustrates a flowchart 1500 for a computer-implemented method for initializing a home Wi-Fi router, in accordance with one or more embodiments set forth and described herein. In order for the home Wi-Fi router 1405 to be utilized as an access point by the computer system 100, the home Wi-Fi router 1405 should be initialized with the computer system 100 (attached to a motorcycle or other vehicle). Initially, in process block 1501, the identity (e.g., the SSID) of the home Wi-Fi router 1405 is identified to the computer system 100. This may be done by a user typing or selecting this name on an interface on the computer system 100. The user would also supply the access credentials (e.g., encryption type, password(s), etc.) to the computer system 100 so that the computer system 100 may access and utilize the home Wi-Fi router 1305 to communicate (both send and receive) data to remote parties using the computer communications network (e.g., the Internet). From process block 1501, the method may continue to process block 1502 which identifies the physical location of the home. For example, a GPS device associated with the computer system 100 may determine the actual (or approximate) physical location of the home Wi-Fi router 1405 by using its own location (which presumably is not far from the home Wi-Fi router 1405) when the user instructs the computer system 100 to locate itself. The user may also type in the physical address of the home (which is where the home Wi-Fi router 1405 would be located). The physical location/address of the home Wi-Fi router 1405 would be stored on a remote server (e.g., server 102) and/or also the computer system 100 so that it may be determined when the computer system 100 (which also has its own GPS device) is near the home Wi-Fi router 1405. From process block 1502, the method may proceed to process block 1503, which sets rules regarding utilization of the home WI-FI router 1405. The rules determine when the computer system 100 would utilize the home WI-FI router 1405 to connect to the internet. In one configuration, the computer system 100 would never utilize the home WI-FI router 1405. In another configuration, the computer system 100 would automatically switch (from using the cellular phone) over to the WI-FI router whenever the computer system 100 was in range of the Wi-Fi router 1405. In a further configuration, the computer system 100 would, once in range of the Wi-Fi router 1405, prompt the user whether to switch from utilizing the cellular phone to utilizing the home Wi-Fi router. When the computer system 100 is powered down (e.g., once the motorcycle or other vehicle has returned to the home 1404) it typically may have to refresh or sync some files (e.g., upload any trip logs, etc.) and the configuration may determine whether to utilize the cellular phone to perform the update or utilize the Wi-Fi router 1305 to perform the updates.

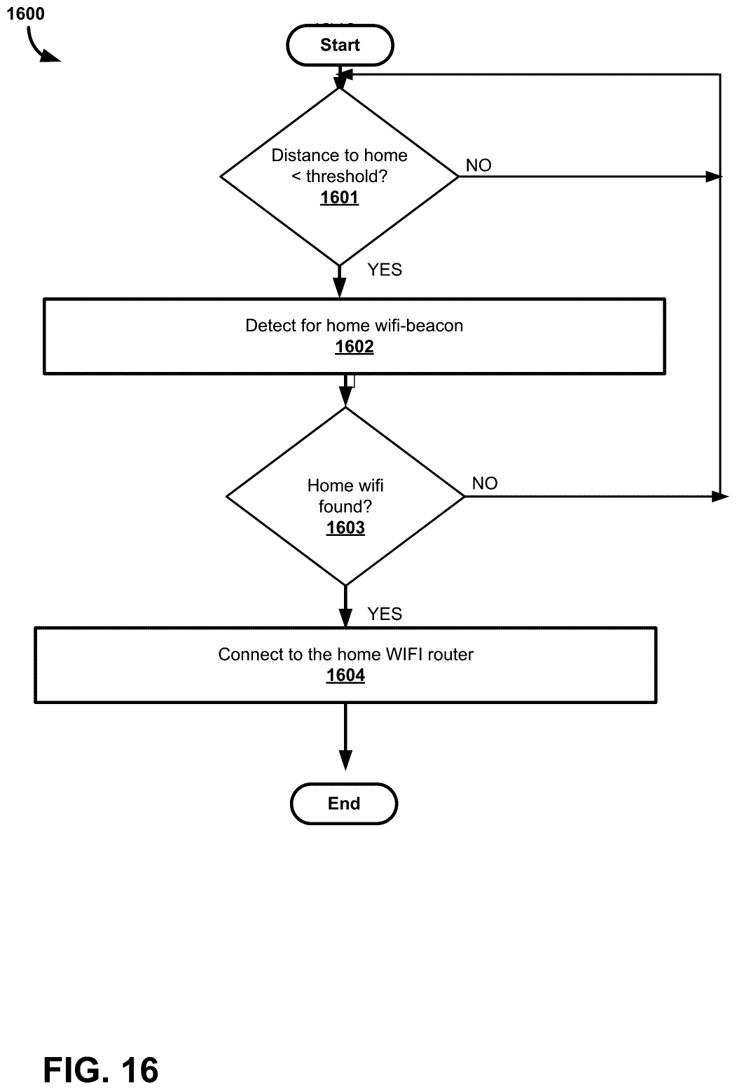

FIG. 16 illustrates a flowchart 1600 for a computer-implemented method for switching communication from a first access point to the home Wi-Fi router, in accordance with one or more embodiments set forth and described herein. In decision block 1601, it is determined whether a distance from the computer system 100 (attached to the motorcycle or other vehicle) to the home (or home WIFI router 1605) is less than a threshold. The location of the computer system 100 may be determined by a GPS device connected to the computer system 100. The location of the home 1404 and/or the WIFI router 1405 is typically already determined and entered into the system (see FIG. 15). The threshold may be a relatively short distance which may be used to determine if the motorcycle (or other vehicle) is “home” such as 20-100 feet or other distance. If the distance is not smaller than the threshold, then the computer system 100 is not near the WIFI-router 1305 and the method would return to decision block 1601 which would continue to check the distance in real time.

If in decision block 1601, the distance from the computer system 100 to the home 1404 (or home WIFI router 1405) is less than the threshold, then the method proceeds to process block 1602, which detects a home WIFI beacon (wireless such as using the 802.11 protocol using radio waves). The home WIFI router 1405 transmits the home WIFI beacon which may be detected by computers and used to connect to the home WIFI router 1405. In decision block 1603, if the computer system 100 does not detect the home WIFI router 1405 (via the beacon), then the method returns to decision block 1601.

If in decision block 1603, the computer system 100 detects the home WIFI router 1405 (via the beacon), then the method proceeds to process block 1604, which connects to the home WIFI router 1605 so that the computer. Note that the computer system would follow any rules set regarding connecting to the home WIFI router 1405 (see process block 1503). The computer system 100 may now continue any data transmission over the internet (or any other computer communications network) using the home WIFI router 1405. If the computer system 100 needs to complete any downloads or uploads (e.g., uploading a trip log or downloading an updated navigation map), it may do so now using the home WIFI router 1405.

Note that some vehicles, such as motorcycles or other vehicles, may not have a direct wireless access to the Internet and so instead they may utilize a user's cellular phone 104 or portable computer to communicate. For example, a user's cellular phone or portable computer may connect to the vehicle's on-board computer (via a wired connection, such as a USB cable, etc.) which may transmit any type of data about the vehicle the on-board computer knows about. Such data may include, for example, historical speed data, seat belt usage, times the vehicle is in use, GPS location of the vehicle at particular points in time, and any other such data. The vehicle's on-board computer may comprise a USB port which in addition to communication, may also be used for charging external devices (such as a portable computer and/or cellular phone).

In addition, the vehicle's on-board computer may wirelessly connect to a user's cellular phone and use the cellular phone as a bridge to the Internet. This may be done in numerous ways. For example, the on-board computer may connect to the cellular phone using the phone's Wi-Fi hotspot functionality. For example, the user may enable the cellular phone's hotspot feature, and then utilize a Graphical User Interface (GUI) on an output device on the vehicle (connected to the vehicle's on-board computer) to pair to the cellular phone utilizing Wi-Fi signals. The SSID of the cellular phone's hotspot Wi-Fi signal may be identified to the on-board computer (using the GUI) and the password to the hotspot Wi-Fi signal may be entered. The on-board computer may then use these credentials (SSID name and password) to connect to the cellular phone's hotspot connection. One possible navigation structure that may be implemented on a menu is “Settings>Wi-Fi>Discover and Select Hotspot/Wi-Fi Network>Password>Click through terms>Wi-Fi functionality now enabled.” Once connected in such a manner, the on-board computer is then paired wirelessly to the cellular phone using Wi-Fi and may access the internet (sending and receiving data) as needed. Note that the user may request that the on-board computer forget about Wi-Fi networks as well (which would require the user to re-enroll a forgotten Wi-Fi network if the user wishes to reactivate it).

Another method that the vehicle's on-board computer may utilize to connect to the user's cellular phone and utilize the cellular phone's internet connection is by Bluetooth pairing. The user may enable Bluetooth on the user's cellular phone. The vehicle's on-board computer may be requested to identify any Bluetooth beacons that it may detect, and the user may then select the name of the cellular phone's Bluetooth beacon. The on-board computer may then complete a handshake with the cellular phone using Bluetooth communication, and a code may be displayed on the vehicle's output device. This same code may be communicated to the cellular phone which may be displayed on the cellular phone display. The user would confirm that the code is the same on both devices (the on-board computer display and the cellular phone display) and press a confirm button on both devices. If the codes do not match, then the user should not complete the confirmation process. Once confirmed, the on-board computer may then communicate with the cellular phone utilizing a standard Bluetooth wireless protocol, and the on-board computer may then access the internet (sending and receiving data) utilizing the cellular phone's internet connection.

A further method may be utilized to connect the vehicle's on-board computer to the internet. An infotainment application is a software application that implements common features associated with driving a vehicle, such as navigation, music, messaging, etc. Such infotainment applications may mirror or utilize the vehicle's output device (connected to the vehicle's on-board computer) in addition to (or alternative to) the output device on the user's cellular phone so that the user may easily interact with the GUI displayed on the vehicle's output device. The user's cellular phone is accessed by the on-board computer so that content from the cellular phone may be utilized by the on-board computer, such as streaming audio, navigation maps, contacts, messaging, etc. The user may connect to the internet via an infotainment application by first utilizing the vehicle's GUI on the vehicle's output device and selecting to activate an infotainment application. Once selected, the on-board computer would then wirelessly pair with the cellular phone utilizing Bluetooth in the same manner as described above. Alternatively, instead of Bluetooth, the cellular phone may also be paired with the on-board computer using Wi-Fi (as discussed above) or a wired connection (as discussed above). Once the on-board computer is paired with the user's cellular phone, the infotainment application (typically being executed on the on-board computer) would then be able to access the Internet (transmitting and receiving data) using the cellular phone as a bridge. The infotainment application would also utilize a GUI displayed on the output device on the vehicle in order to provide the user with enhanced functions related to the operation of the vehicle, such as navigation instructions (using GPS), playing audio, displaying text messages received from the cellular phone, etc.

Note that software updates may be automatically (or manually) downloaded to the on-board computer and executed over the air (OTA), meaning wirelessly from a remote server. If there is no active Wi-Fi connection (or other internet connection), then receiving updates over-the air may not be possible. A server (such as server 102) may store updates to software for a number of different vehicles. Updates may be categorized by particular vehicles that they are intended for. The server/database may store a list of particular vehicles (e.g., identified by the VIN numbers, infotainment serial numbers, etc.) and their type (e.g., car, motorcycle, including their model name). Updates may be automatically transmitted to vehicles that are compatible with respective updates. For example, a particular update would only be compatible with motorcycles manufactured by a certain company of model X in years 2021 and 2022. The database may identify all of the particular vehicles which were manufactured by the certain company of model X in years 2021 and 2022 and return their identifying information (e.g., VIN number, infotainment serial numbers, etc.). From this information, updates to the vehicle's software (e.g., BIOS, operating system, applications, etc.) may automatically be routed to these particular vehicles through the infotainment application (which when activated may transmit its vehicle's identifying information (e.g., VIN number, infotainment serial numbers, etc.) to the server. In this manner, the server would maintain in real time a list of vehicles, their identifying information, and their respective IP addresses so that updates may be sent over the air in real time. When a vehicle's on-board computer receives an update, an alert (e.g., message, pop-up, etc.) may be displayed on the vehicle's display indicating that there is a software update for download. The user can accept the update (which would start the download an installation process), delay the update or reject the update (e.g., by termination the Wi-Fi connection).

If the user accepts the software update, the software update would be downloaded to the on-board computer of all of the applicable vehicles for that update. The vehicle and the on-board computer can be utilized in a normal fashion during the download, as the download may reside in partitioned memory/storage. This allows the infotainment application and other systems to be used as normal. Once downloaded, there may be a verification operation to confirm that the download was complete (e.g., checksum, checking file size, digital signatures, etc.)

Once the download is complete, a message (e.g., pop-up, alert, etc.) on the vehicle's output display may inform the user that the software update is ready to install. There may be instructions on what state the vehicle (e.g., motorcycle) needs to be put into in order to complete the update (e.g., put into park, attach a battery tender, etc.) During the update process, the vehicle should not be used in its normal manner. During the update process, the infotainment application/system (and other systems) may restart. The new software would replace the old software, and the new software may move from the partition section of storage to the main/live section of the storage. Once installed, there may be a system/software check to verify that the installation was successful.

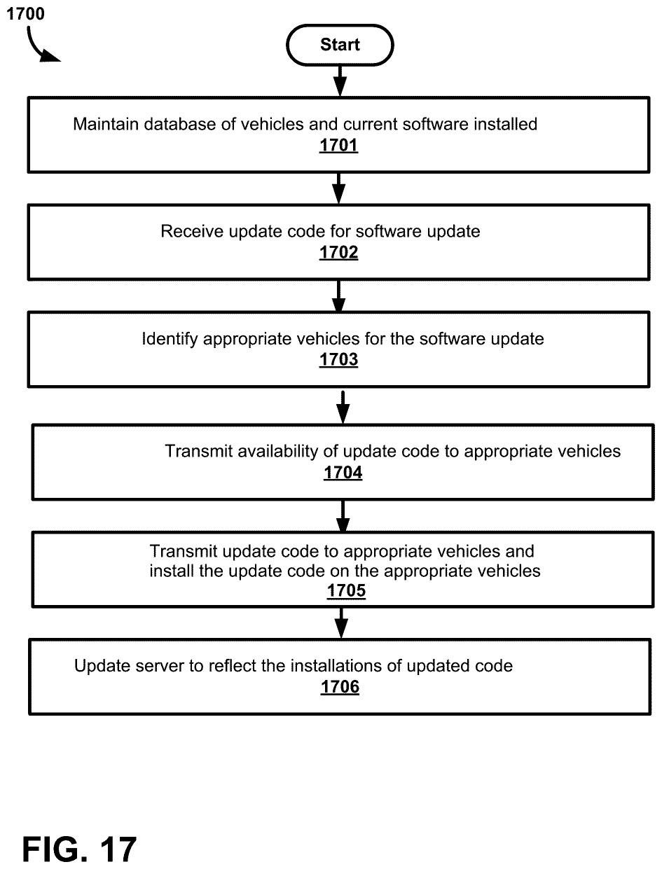

FIG. 17 illustrates a flowchart 1700 for a computer-implemented method for implementing software updates for vehicles over the air, in accordance with one or more embodiments set forth and described herein. In operation 1701, the server maintains a database of vehicles and their current software installed. All updates may be directed by the central server so that the central server may maintain an event log storing the currently installed versions of all software installed on all of the on-board computers of all vehicles maintained by the central server. Whenever a new vehicle is sold or manufactured, the server may be updated with the existence of the new vehicle including details about it (e.g., model, year, vehicle identification number (VIN), current software version, etc.)

From operation 1701, the method may proceed to operation 1702 wherein the server may receive update code from the software developers for the vehicles maintained by the server. Software that is updated can be various software utilized by the vehicle, such as operating systems, bios, infotainment systems, etc. Periodically the software developers improve their code and will post updates to the server.

From operation 1702, the method proceeds to operation 1703, which would identify appropriate vehicles known to the server which are compatible with the software update. Certain updates would only apply to certain versions of vehicles or certain software packages that may be on some vehicles but not others. The server would maintain such a list of all vehicles known to the server (e.g., manufactured by a particular vehicle manufacture), their model type, year, VIN number, all software modules installed on the on-board computer of that vehicle and their respective versions, and any other information that may be associated with each vehicle and its on-board computer.

From operation 1703, the method may proceed to operation 1704, which would wirelessly transmit the availability of the update to the identified vehicles from operation 1703. Note that this is not yet transmitting the actual code, only the existence (availability) of the code so that the user of each respective vehicle may then decide whether to initiate the update at the time or postpone it (as described herein).

From operation 1704, the method proceeds to operation 1705, which transmit and installs the update code on each of the appropriate vehicles. Note that this is only done for each vehicle when the user of each vehicle has approved of and initiated the update, as described herein. This operation may be performed by first transmitting the actual code over the air (wirelessly) to the appropriate vehicles (as described herein). This is done by cooperation with the server (transmitting the updated code) and the on-board computer for each vehicle (receiving the updated code). Once the code has been received by the on-board computer, the on-board computer would then initiate the installation of the updated code (as described herein).

From operation 1705, the method proceeds to operation 1706, which then updates the server (which includes any relational database used by the server) to reflect the software updates that were performed. In this manner, the server would know each vehicle manufactured by the manufacturer, and the latest versions of software installed on the vehicle (including its on-board computer). Note that all milestones (as described herein) may be updated in the server as well. So that the server maintains a log of all events related to software updates and related transactions.

On the server side, milestones can be stored for later reference. For example, each time a new software alert was sent (or unable to be sent), a user accepts or rejections a software download, a software download was successful or unsuccessful, a software verification passed or failed, a user accepts or rejects an installation of software, a software installation was successful or unsuccessful, etc., each of these events can be stored in the database identifying the user, vehicle, and what event actually took place. Furthermore, if a vehicle has an earlier version and the user wants to upgrade to a later version, the versions should be upgraded sequentially. For example, if a vehicle has version 1 and the user wants to upgrade to version 3, the system would have to download and install version 2 first in order to ensure no assets are missing for later versions.

The system and method described herein may be at least partially processor-implemented, the one or more processors being an example of hardware. For example, at least some of the operations of the computer-implemented methods may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a plurality of machines. In some example embodiments, the one or more processors or processor-implemented modules may be located in a single geographic location (e.g., within a home environment, an office environment, or a server farm). In other example embodiments, the one or more processors or processor-implemented modules may be distributed across a plurality of geographic locations.

Devices that are described as in “communication” with each other or “coupled” to each other need not be in continuous communication with each other or in direct physical contact, unless expressly specified otherwise. On the contrary, such devices need only transmit to each other as necessary or desirable, and may actually refrain from exchanging data most of the time. For example, a machine in communication with or coupled with another machine via the Internet may not transmit data to the other machine for a long period of time (e.g. weeks at a time). In addition, devices that are in communication with or coupled with each other may communicate directly or indirectly through one or more intermediaries.

The terms “coupled,” “attached,” or “connected” may be used herein to refer to any type of relationship, direct or indirect, between the components in query, and may apply to electrical, mechanical, fluid, optical, electromagnetic, electromechanical, or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action may occur, either in a direct or indirect manner.

Those skilled in the art will appreciate from the foregoing description that the broad techniques of the exemplary embodiments may be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. A method of predicting whether a vehicle is returning to a location and conditionally initiating an automatic action, the method comprising:
determining, using one or more processors, that the vehicle is headed towards the location and that a driving distance to the location is lower than a predetermined distance; and
initiating, using the one or more processors, in response to the determining, an action.

2. The method of claim 1, wherein the initiating the action comprises opening a garage door at the location.

3. The method of claim 1, wherein the initiating of the action comprises opening a window on a user interface.

4. The method of claim 1, wherein the determining that the vehicle is headed towards the location comprises determining that a driving distance between the vehicle and the location is decreasing.

5. The method of claim 1, further comprising,
training a machine learning model using historical GPS data for a driver of the vehicle; and
using the machine learning model to determine a score indicative of whether the driver is intending to return to the location,
wherein the initiating is also based on the score.

6. The method of claim 5, wherein the historical GPS data comprises a set of physical locations the vehicle was at and times the vehicle was at those respective locations.

7. The method of claim 5, further comprising maintaining separate training data for respective drivers of the vehicle.

8. A computer program product comprising at least one non-transitory computer readable medium having with a set of instructions of computer-executable program code, which when executed by one or more processors of a computing device, cause the computing device to:
determine whether a vehicle is headed towards a location;
determine whether a driving distance to the location is lower than a predetermined distance; and
initiate, when the vehicle is headed towards the location and the driving distance to the location is lower than the predetermined distance, an action.

9. The computer program product of claim 8, wherein the action comprises opening a garage door at the location.

10. The computer program product of claim 8, wherein the action comprises opening a window on a user interface.

11. The computer program product of claim 8, wherein the determine whether the vehicle is headed towards the location comprises determining that a driving distance between the vehicle and the location is decreasing.

12. The computer program product of claim 8, wherein the set of instructions is further programmed to cause the computing device to perform:
training a machine learning model using historical GPS data for a driver of the vehicle; and
using the machine learning model to determine a score indicative of whether the driver is intending to return to the location,
wherein whether the initiate is performed is also based upon the score.

13. The computer program product of claim 12, wherein the historical GPS data comprises a set of physical locations the vehicle was at and times the vehicle was at those respective locations.

14. The computer program product of claim 13, wherein the set of instructions is further programmed to cause the computing device to perform: maintaining separate training data for respective drivers of the vehicle.

15. An apparatus, comprising:
one or more processors;
a non-transitory memory coupled to one or more processors, the non-transitory memory including a set of instructions of computer-executable program code, which when executed by the one or more processors, cause the apparatus to,
determine whether a vehicle is headed towards a location;
determine whether a driving distance to the location is lower than a predetermined distance; and
cause, when the vehicle is headed towards the location and the driving distance to the location is lower than the predetermined distance, performance of an action.

16. The apparatus of claim 15, further comprising:
a motorcycle attached to the one or more processors and the non-transitory memory.

17. The apparatus of claim 15, wherein the set of instructions, which when executed by the one or more processors, enables the action to comprise opening a garage door at the location.

18. The apparatus of claim 15, wherein the set of instructions, which when executed by the one or more processors, enables the action to comprise opening a window on a user interface.

19. The apparatus of claim 15, wherein the set of instructions, which when executed by the one or more processors, further causes the apparatus to:
train a machine learning model using historical GPS data for a driver of the vehicle; and
use the machine learning model to determine a score indicative of whether the driver is intending to return to the location,
wherein whether the performance of the action is performed is also based upon the score.

20. The apparatus of claim 19, wherein the historical GPS data comprises a set of physical locations the vehicle was at and times the vehicle was at those respective locations.
